(19) United States
(12) Patent Application Publication
(10) Pub. No.: US 2003/0081648 A1
(43) Pub. Date: May 1, 2003

(54) Temperature measuring device for movable machine elements

(75) Inventor: Klaus Meier, Eislingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: ZINSER SYNTHETICS GMBH

(21) Appl. No.: 10/279,038

(22) Filed: Oct. 23, 2002

(30) Foreign Application Priority Data
Oct. 25, 2001 (DE) 10152619.9

(51) Int. Cl. G01K 1/16; G01K 1/14

(52) U.S. Cl. 374/141; 374/208

(57) ABSTRACT

A system for measuring the temperature in a large number of galettes of a spinning or winding machine for synthetic filaments to limit the spread in measurements of the actual temperature of the galettes in control of galette temperature in which the temperature sensor at the end of a holding and/or protecting element extending into an annular groove in the respective galette and supported by a mounting on the machine frame. A thermal barrier of plastic, glass or ceramic is provided between the sensor and the machine frame to reduce or eliminate conduction of heat from the sensing element to the machine frame.

### FIELD OF THE INVENTION

My present invention relates to a temperature-measuring system for a movable machine element and especially a galette of a spinning machine. More particularly, the invention relates to a system for measuring the temperature of a moving machine part in which the machine part has a rotatable member whose temperature needs be maintained within narrow limits or tolerances and, in the course of which the temperature is measured.

### BACKGROUND OF THE INVENTION

While the measurement of temperatures in moving machine parts may be a problem in various fields, it is particularly a problem in conjunction with galettes of spinning, twisting and winding machines in which a yarn, thread or filament is passed around a sleeve which rotates relative to a housing or support. In the synthetic filament field, the use of heated galettes and similar moving elements as part of the filament stretching system is quite common. The measurement of the temperature of this moving part is a problem which has been attacked in the past (see DE 195 13 951 and the corresponding U.S. Pat. No. 5,712,467, for example).

Spinning, twisting and winding machines with the capability of stretching the thread or filament and using galettes require that the latter pass around the rapidly rotating sleeve at each spinning or twisting station and thus requires a typical stretch-spinning or stretch-twisting machine for synthetic filaments to have a large number of heated galettes or sleeves, the surface temperatures of which must be maintained with a relatively high precision and, in conjunction therewith, must be measured by appropriate temperature sensors.

In the past this has been done at least in some cases by temperature sensors fixed on a support structure, e.g. the spinning or twisting machine frame, and extending into an annular gap in the sleeve forming the outer surface of the galette and along which the filament is passed.

In order to maintain the temperature at the surface of the galette within a narrow range, a precision temperature sensor was required and to keep the cost reasonable, considering the large number of galettes and sensors, it was proposed to determine an offset of the temperature which was associated with the particular galette and to correct the temperature so that it was within the range of tolerances permitted by this method. The measured temperatures were thus compared to reference values and the temperature was adjusted taking into consideration the offset assigned to the particular galette. The offset varied from galette to galette because of a comparatively large spread in the difference between the actual temperature at the surface of each galette and the measured value of the temperature outputted by the sensor assigned to that galette.

The problem was even more pronounced by the fact that the measurement or comparison led to a certain lag in correction of the temperature and thus an additional difference between the measured temperature and the actual temperature at the surface. The temperature measurement and corrections were not continuous in many cases and hence an additional lag was introduced by the fact that the measurement and corrections were carried out at time-spaced intervals.

As a consequence, earlier techniques, regardless of the precision of the temperature sensor, were not fully capable of maintaining narrow tolerances in control of temperature, i.e. variations in the temperature of the galette surface which were less than say 10 K.

### OBJECTS OF THE INVENTION

It is, therefore, the principal object of the present invention to provide an improved system for measuring the temperature of a moving machine element, especially a galette of a spinning machine, which will result in a reduced spread of the detected temperature from unit to unit in the machine and which can, if possible, eliminate the need for calculating offsets from unit to unit.

Another object of this invention is to provide a temperature measuring system, especially for a rotating galette of a spinning machine, but suitable wherever a multiplicity of moving machine elements can be provided, whereby the control of the temperature at a surface of such an element is improved and variation in the measured temperature from machine element to machine element is reduced.

Still another object of the invention is to provide an improved device for measuring the temperature at a surface of a rotating galette.

### SUMMARY OF THE INVENTION

These objects and others which will become apparent hereinafter are attained, in accordance with the invention which provided, in a system in which the temperature of a moving machine element is measured by a temperature sensor which is stationary and which reaches into the moving part, means for reducing the conduction between the temperature sensor and the machine housing for support.

More particularly, a device for measuring the temperature of a movable machine element and especially a galette of a spinning machine can comprise the temperature sensor reaching into the moving machine element, a member connecting that temperature sensor with a fixed part of that machine and an arrangement whereby the holding and/or protecting element for the temperature sensor is so configured that there is an increase in the heat-conductivity resistance between the temperature sensor element and the stationary machine part. Either the mounting member on the machine part or the connecting member by means of which the sensing element is connected to the mounting member can be made as a part of limited thermal conductivity.

According to a feature of the invention, the machine element is the rotatable sleeve or shell of a galette and is mounted upon the machine stand in such manner that an annular gap or groove inwardly of the galette surface is open toward that stand and the temperature sensor extends into the annular groove on an arm connected by a mounting to the stand. The arm and mounting form a holding element and where the arm is a tubular member can also constitute the protective elements for the sensor which can be located in that arm. At least a part of the arm or a part of the mounting or both are composed of low thermal conductivity material.

The low thermal conductivity material can itself be a suitable synthetic resin, ceramic or glass.

The cross section of the holding element and/or the protective element should at least over the part mentioned be of low thermal conductivity. The protective element, for example, can be a tube closed at one side and the temperature sensor can be mounted in the tube. Preferably the temperature element is bridged to the tube by a material of high thermal conductivity. The material may be a solder or heat-conducting adhesive.

The temperature sensor in either case is in good thermal conducting relationship with its support and that material of high thermal conductivity can be a metal. The temperature sensing element, as noted, can be mounted in the closed end of the tube or on the end of the tube with a material of high thermal conductivity and in all cases the temperature sensitive element should be protected from environmental effects, for example, of vapors from the preparation of the synthetic filament. To that end, the temperature sensor may be provided within a wall which cannot be penetrated by such vapors.

I have discovered that, to a large measure, the variability from one temperature sensor to another in multisensor arrangements like the galette temperature sensor of a spinning or twisting machine is apparently due to the different degrees of conduction of heat from the temperature sensors to the machine frame and that by significantly reducing the heat flow in the mounting of the sensors, that variability can be significantly reduced. In stretch spinning and stretch twisting machines, for example, provided with large numbers of galettes, the temperature sensors are usually formed with Pt 100 sensors which can be disposed in tubes open at one end and extending like fingers into the annular groove of the galette, the open end of the tube being mounted on the machine frame.

In such assemblies, in the past, there has been considerable variability heat conduction from the sensor to the machine frame, significant influence of the filament preparation vapor upon the sensors and, in general, significant differences in temperature measurement from one galette to the other.

Within the groove itself, when the galette sleeve rotates at high seed, there is significant turbulence so that the thermal conduction between the sleeve and the temperature sensor that the tube in which it is mounted is considerable. However, there are variations in the thermal conduction between the sensor and the tube along the tube and in the mounting of the tube on the machine frame.

When, according to the invention the tube or the mounting or both are provided with portions of low thermal conductivity material at least between the temperature sensing element and the mounting point on the machine frame, conduction of heat away from the temperature sensor is minimized. When the tube has a high thermal conductivity connection to the sensor at the closed end of the tube, interference with accurate temperature measurement is reduced and when the temperature sensor is protected within the tube from the vapor, environmental effects are eliminated.

The tube has its open end fixed in the machine housing or a mounting element connected thereto and with the invention, there is no falsification of the actual values measured resulting from the variability of the conduction of heat from the tube to the machine frame.

Preferably the outer wall of the sensor is in direct contact with the tube and/or is connected therewith by an adhesive having a high thermal conductivity. To the extent the sensor permits, it can be soldered or heated directly to the tube where the temperature sensor is mounted externally of the tube on the front end of this holding element, the sensor itself must be sealed against the preparation vapors or other environmental effects.

### BRIEF DESCRIPTION OF THE DRAWING

The above and other objects, features, and advantages will become more readily apparent from the following description, reference being made to the accompanying drawing in which:

FIG. 1 is a diagrammatic cross sectional view of one arrangement of the temperature sensing assembly in accordance with the invention;

FIG. 2 is a view similar to FIG. 1 showing a second arrangement;

FIG. 3 is another view similar to FIG. 1 illustrating still a third temperature sensing arrangement; and

FIG. 4 is a diagrammatic illustration of a system using the sensing arrangement of FIG. 1, 2 or 3.

### SPECIFIC DESCRIPTION

In FIG. 4 I have shown a rotating machine element 100 which is mounted at 101 on a stationary machine part 102. In this case the rotating machine part is a heated galette of a winding machine, e.g. a spinning or twisting machine for synthetic resin filament thread 103 which is shown diagrammatically as passing around the cylindrical shell of the galette. The latter is provided with a heating unit 104, illustrated as a heating resistor connected to a temperature controller 105 which also receives an input from a temperature sensor 106 extending from the support into a groove 107 of the galette. The principles of such a system are to be found in U.S. Pat. No. 5,712,467 referred to earlier.

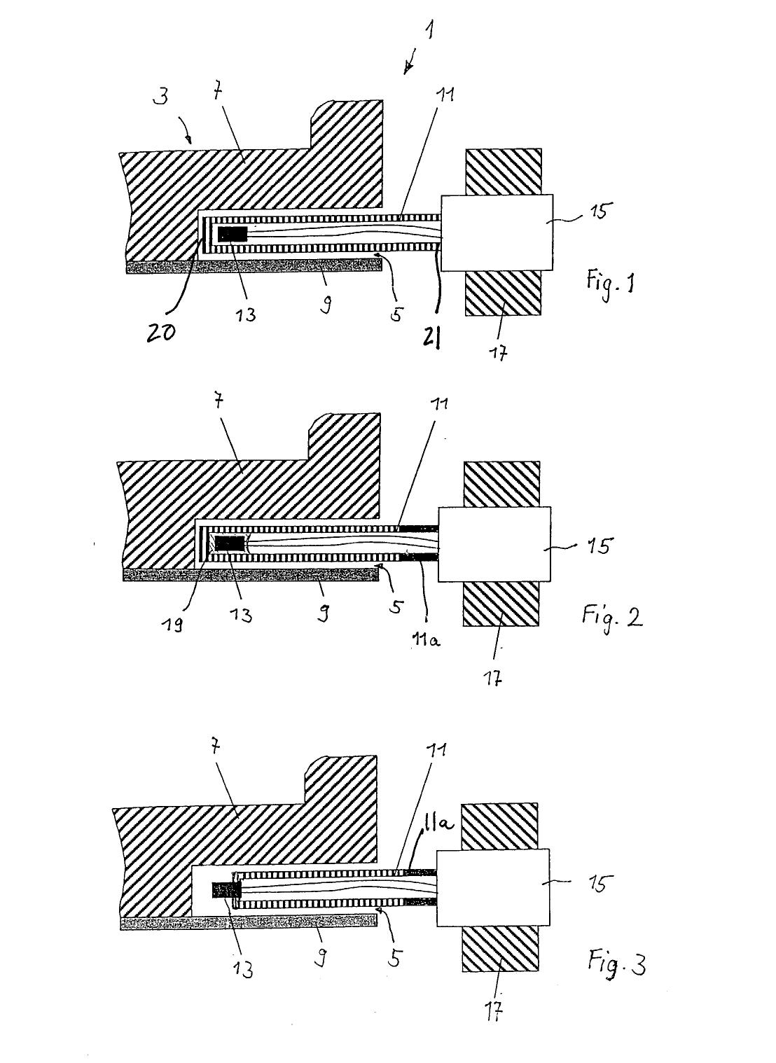

The present invention is directed primarily to the part of this system which concerns the temperature sensor. FIGS. 1-3, therefore, show a galette for a stretch winding or stretch spinning machine in greater detail. It will be understood that such a galette may be located at which the spinning station and that galettes should hold the temperatures of the filament or thread to a preset temperature with a minimum spread and that, as a consequence the temperature spread from galette to galette has been a problem heretofore and has now been provided in large measure to the temperature sensor system.

In FIG. 1, for example, the important components of a galette unit 1 of such a machine has been shown in part and only a portion of the rotating galette can be seen in this Figure. Here sleeve 3 or cup-shaped part of the galette unit 1 has been illustrated and the drive for the galette has not been shown. In the annular gap or groove 5 formed between a recess in the galette shell 7 and a front circuit ring 9 forming a component of the inductive heating system for the galette 3, a holding and/or protective element 11 engages in the annular gap 5 and carries a temperature sensor 13. The holding and/or protective element 11 can be, as FIG. 1 shows, a tube closed at one end 20 and mounted at its opposite end 21 in a part 15 which in turn supports the tube on the machine frame member represented here diagrammatically at 17. The temperature sensor 13 can for example be a PT 100 temperature sensor or some other thermo-element. In the embodiment of FIG. 1, the temperature sensor 13 is loosely received in the front end of the tube 11 close to the closed end 13.

The member 15 can, if desired, be received in the machine stand 17 or simply attached thereto or attached thereon. In the embodiment of FIG. 1, the part 15 is composed of a material of poor heat conductivity, for example, a plastic, ceramic or glass.

As a consequence, the heat to which the temperature-measuring element 13 is subjected cannot be conducted away from the tube 11 and the sensor 13 and the tube 11 may be composed of a material of high thermal conductivity such as a metal.

Since there is practically only a negligible loss of heat from the element 13 for the tube 11 and the part 15 to the machine stand 17, the accuracy of the temperature measurement is high and variability in the control temperature of the galette 3 resulting from a high variability in losses to the stand 17 as a result of the high temperature difference between the galette and the stand is minimal.

The effect of such losses on the measurement of the actual temperature is thus practically eliminated and control of the temperature via a system of the tube shown in FIG. 4 can be maintained with significantly greater precision. There is a reduced spread of temperature from unit to unit and reduced contributions to such a spread because of different positions of the temperature-sensing element 13 in the tube 11 and different depths to which the tube 11 extends into the groove 5 in the galette.

In the embodiment of FIG. 2, the sensor 13 is anchored in the tube 11 by solder or a thermally-conductive adhesive, i.e. a material of high thermal conductivity, so that the sensors can be located also with high precision at the front end of the tube. This of course further reduces the spread in actual value measurement of the temperature.

In the embodiment of FIG. 2, moreover, a rear portion 11a of the tube 11 is constituted as a material of low thermal conductivity, e.g. plastic, ceramic or glass. The part 15 in this case can be composed of a material of good thermal conductivity. The thermal barrier is here formed by the tube segment 11a.

For simplification in manufacture, the front part of the element 11 can be a metal tube while the rear part can be a tube of plastic, glass or ceramic which is forced over the end of the metal tube and serves to mount it on member 15.

The combination of high thermal conductivity of the sensor 13 and the front portion of tube 11 with a thermal barrier between the rear part of that tube and the support frame ensures a reduction in the spread of the measured temperatures from unit to unit in the system.

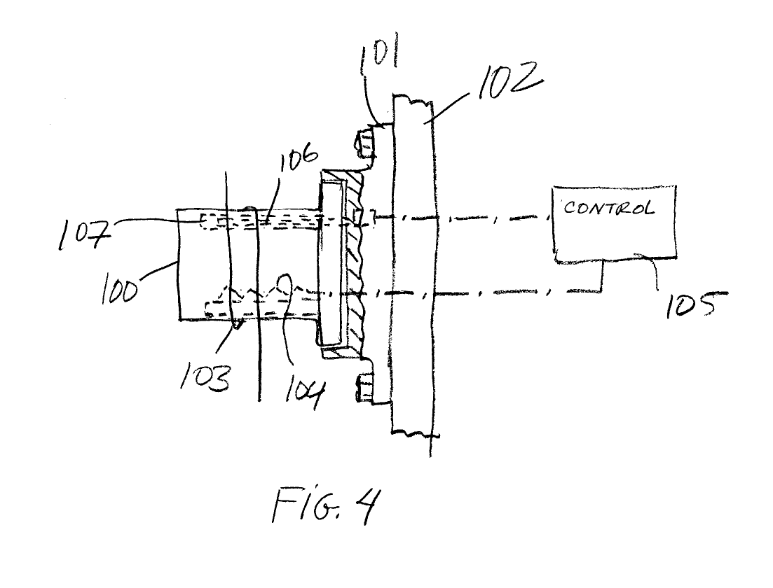

FIG. 3 shows a system which is analogous to that of FIG. 2 in which the thermal barrier is provided at 11a between the metal tube portion 11 and the mounting 15 for the temperature sensor on the machine frame 17, but wherein the temperature element 13 itself is not located within the tube 11 but rather projects therefrom at the front end of the tube 11. The tube 11 does not here act as a protective member for the temperature sensor 13 but only as a holder. The sensor 13 itself must therefore be a sensor which is insensitive to environmental effects in the gap 15 and in particular must be protected against the vapors which are associated with the synthetic filament, i.e. so-called preparation vapors. The sensor in this case can be a thermo-element of NiCrNi.

Alternatively, the entire tube 11 can here be composed of the material of low thermal conductivity since the sensor in the embodiment of FIG. 3 is located at precisely the point in space that the temperature measurement is to be made. In this embodiment as well there is a significant spread in results from unit to unit.

I claim:

1. An apparatus for measuring a temperature of a machine element moving relative to a support, comprising:
a temperature sensor extending into said moving element and positioned at a location therein at which a temperature is to be measured in a gap maintained by said moving element during movement thereof;
a holding element mounted at one end of said support, extending into said gap and receiving said sensor for positioning same in said gap; and
a thermal barrier formed along said holding element between said sensor and said support for limiting thermal conductivity between said sensor a said support.

2. The apparatus defined in claim 1 wherein said machine element is a rotating machine element having an annular gap open toward said support, said holding element extending into said gap from said support.

3. The apparatus defined in claim 2 wherein said machine element is a galette of a spinning machine.

4. The apparatus defined in claim 3 wherein said holding element is a tube having one end receiving said sensor and another end connected by a mounting to said support.

5. The apparatus defined in claim 4 wherein said mount is composed of a material of low thermal conductivity.

6. The apparatus defined in claim 5 wherein said material of low thermal conductivity is selected from the group which consists of a plastic, a ceramic or a glass.

7. The apparatus defined in claim 4 wherein said tube has a tube segment composed of a material of low thermal conductivity and forming said thermal barrier.

8. The apparatus defined in claim 7 wherein said material of low thermal conductivity is selected from the group which consists of a plastic, a ceramic or a glass.

9. The apparatus defined in claim 4 wherein said tube is composed of a material of low thermal conductivity.

10. The apparatus defined in claim 9 wherein said material is selected from the group which consists of a plastic, a ceramic or a glass.

11. The apparatus defined in claim 4 wherein said sensor is located within said tube and is protected thereby against vapors generated in the production of a synthetic filament passing around said galette.

12. The apparatus defined in claim 11 wherein said front end of said tube is closed.

13. The apparatus defined in claim 12, further comprising a material of high thermal conductivity bonding said sensor to said tube at said front end thereof.

14. The apparatus defined in claim 12 wherein at least said front end of said tube is of high thermal conductivity.

15. The apparatus defined in claim 14 wherein said front end of said tube is composed of metal.

16. The apparatus defined in claim 4 wherein said sensor is mounted on said front end of said tube and lies outside said tube.

17. The apparatus defined in claim 16 wherein said sensor is provided with protection against vapors resulting from preparation of a synthetic filament passing around said galette.
